(19) United States
(12) Patent Application Publication
(10) Pub. No.: US 2011/0279218 A1
(43) Pub. Date: Nov. 17, 2011

(54) DOUBLE WOUND FUSIBLE ELEMENT AND ASSOCIATED FUSE

(75) Inventors: Bienvenido Salonga, Batangas (PH); Francisco De Guia, Laguna (PH); Alvin Salvador, Laguna (PH)

(73) Assignee: LITTELFUSE, INC., Des Plaines, IL (US)

(21) Appl. No.: 13/107,527

(22) Filed: May 13, 2011

Related U.S. Application Data
(60) Provisional application No. 61/345,322, filed on May 17, 2010.

(51) Int. Cl. H01H 85/46; H01H 85/04

(52) U.S. Cl. 337/187; 337/290

(57) ABSTRACT

An improved fusible element for use within a circuit protection device is provided which includes a double wound fusible element configured to withstand high surge current associated with inductive and capacitive loads. The fusible element includes an insulated core having a longitudinal axis, a first wire wound about the core along the longitudinal axis of the core, and a second wire wound substantially orthogonally about a longitudinal axis of the first wire such that the fusible element is configured to withstand an over-current surge condition.

### BACKGROUND OF THE INVENTION

1. Field of the Invention

Embodiments of the invention relate to the field of circuit protection devices. More particularly, the present invention relates to a fuse employing a double wound fusible wire element configured to withstand high surge current associated with inductive and capacitive loads.

2. Discussion of Related Art

Fuses are typically used as circuit protection devices and form an electrical connection with a component in a circuit to be protected. The fuse is designed to protect the circuit or circuit component by being the intentional weak link in the circuit. One type of fuse includes a housing consisting of a plastic base and a plastic cap with a pair of conductors or terminals which extend through the base and are connected via a fusible element that forms a bridge between the terminals inside the housing. In order to fix the terminals inside the base portion of the housing, a portion of each terminal and/or the base is deformed in order to pinch the base around the terminals, thereby clamping the base around the respective terminals. The fusible element is attached to ends of each of the two conductors projecting above the base. The fusible element is typically a conductive wire which is soldered to the ends of the two terminals. The fuse is placed in a circuit to be protected such that the fusible element melts when an abnormal overload condition occurs.

In certain circuit protection applications (e.g. motors, etc.), a surge current or short term current overload situation may typically occur until a steady state condition for the device is achieved. Fuses employed in these types of circuits must be designed to permit this short term surge to pass through the fuse without melting the fusible element. This high-surge condition is defined in terms of current and time (I²t) where it is desirable to avoid an open circuit unless the current exceeds a specific percentage of the fuse's rated current.

One type of fuse used in these applications employs a spiral wound fuse element. In particular, the fuse element comprises a core of twisted yarn fibers with a fuse wire or wound around the core in a spiral pattern. The yarn that comprises the core is typically a ceramic material that is void of any material that could become conductive when the fuse is blown. The wound wire may include a plurality of wire strands configured to provide increased heat absorption indicative of, for example, a slow-blow or time-delayed fuse.

When a circuit overload is encountered, the passage of the excess current through the fuse element causes it to generate heat and thereby elevate the temperature of the fuse wire. In other words, the core acts as a heat sink to draw this heat away from the fuse wire, thereby lowering the temperature of the fuse wire. In this manner, the transfer of heat from the fuse wire to the core lengthens the time required before the fuse wire melting temperature is reached. For higher current-rated fuses, a larger diameter fuse wire is used to withstand higher current passing through the wire and therefore higher temperatures. However, the wound fuse wire is limited in size, thereby limiting the amount of excess current the wire can withstand as well as the amount of heat transfer between the wound wire and the core. Accordingly, there is a need for a fuse that utilizes a wound fusible wire element and a fuse employing the same configured to provide high I2t characteristics on the fuse element that will withstand high surge current associated with inductive and capacitive loads to protect particular types of circuit components and associated circuits.

### SUMMARY OF THE INVENTION

Exemplary embodiments of the present invention are directed to an improved fusible element for use within a circuit protection device having a double wound fusible element configured to withstand high surge current associated with inductive and capacitive loads. In an exemplary embodiment, the fusible element includes an insulated core having a longitudinal axis; a first wire wound about the core along the longitudinal axis of the core, and a second wire wound substantially orthogonally about a longitudinal axis of the first wire such that the fusible element is configured to withstand a plurality of overcurrent pulses without melting.

In another exemplary embodiment, a fuse includes a housing defining a cavity therein, a first end cap attached to a first end of the housing, a second end cap attached to a second end of the housing and a fusible element disposed in the cavity. The fusible element has a first end electrically connected to the first end cap and a second end electrically connected to the second end cap. The fusible element comprises an insulated core having a longitudinal axis, a first wire wound about the core along the longitudinal axis of the core, and a second wire wound substantially orthogonally about a longitudinal axis of the first wire.

In another exemplary embodiment, a fuse includes a housing defining a cavity therein, a first end cap attached to a first end of the housing, a second end cap attached to a second end of the housing, and a fusible element disposed in the cavity. The fusible element has a first end electrically connected to the first end cap and a second end electrically connected to the second end cap. The fusible element comprises an insulated core having a longitudinal axis, a first wire wound about the core along the longitudinal axis of the core and a second wire wound substantially orthogonally about a longitudinal axis of the first wire.

### BRIEF DESCRIPTION OF THE DRAWINGS

FIG. 1 illustrates an exemplary fuse in accordance with an embodiment of the present disclosure.

FIG. 2 is a perspective view of a fusible element in accordance with an embodiment of the present disclosure.

FIG. 2A is a cross-sectional view taken along the longitudinal axis of the fusible element of FIG. 2 in accordance with an embodiment of the present disclosure.

FIGS. 3A and 3B illustrate an exemplary process for forming a double wound fusible element in accordance with an embodiment of the present disclosure.

FIG. 4 illustrates an exemplary fuse utilizing the fusible element in accordance with an embodiment of the present disclosure.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

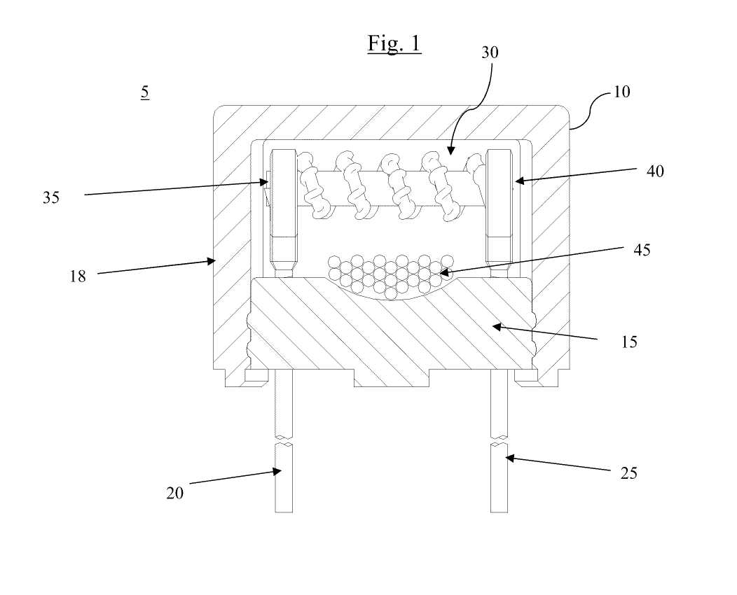

FIG. 1 illustrates a fuse 5 comprising a housing 10 defined by a base 15 and a cap 18. The housing 10 forms a cavity within which a fusible element 30 is disposed. The housing may be formed of plastic or electrically insulating material capable of withstanding heat generated when the fuse is blown. The base and cap may also be made from plastic or other suitable material. A pair of conductors or terminals 20, 25 pass through the base 15 and are electrically connected via fusible element 30 disposed inside the housing 10. The upper ends of terminals 20 and 25 may include, for example, clips that retain ends of fusible element in contact with respective ends of the terminals. Solder portions 35 and 40 are used to connect ends of fusible element 30 to conductors 20 and 25 respectively. Fusible element 30 is shown as being configured in a parallel relationship to the longitudinal surface of base 15 and perpendicular to the longitudinal axis of each of the conductors 20 and 25. When an occurrence of a specified over-current or surge current condition occurs, the fusible element 30 melts or otherwise opens to interrupt the circuit path and isolate the protected electrical components or circuit from damage. In addition, an arc quenching material 45 may also be included within housing 10 to absorb the effects of the arc which occurs when the fusible element 30 melts after, for example, an over-current condition.

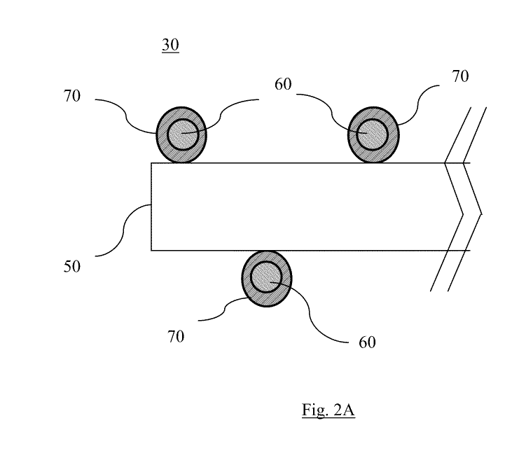

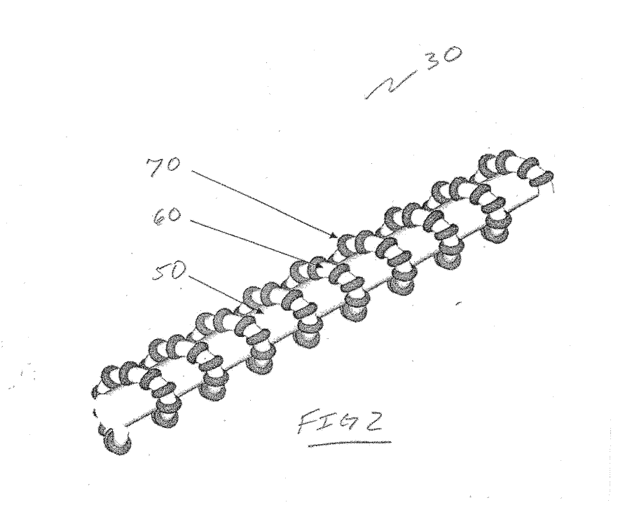

FIG. 2 is a perspective view of just fusible element 30 in accordance with an embodiment of the present disclosure. The fusible element 30 comprises a core 50 formed from an electrically insulating material such as, for example, glass yarn. A double wound wire is disposed around core 50. In particular, the double wound wire is defined by a first wire element 60 wound longitudinally about the core 50 from a first end to a second end and a second wire element 70 wound substantially orthogonally about a longitudinal axis of wire element 60. In other words, the wire element 60 has a longitudinal axis which corresponds to its position with respect to core 50 and second wire element 70 is disposed orthogonally to the longitudinal axis of wire element 60. The combination of wire elements 60 and 70 are wound about core 50 a plurality of turns or windings. The wire elements 60 and 70 used to form the double wound fusible element 30 comprise electrically conductive material configured to melt at a predetermined temperature (i.e. current rating) to interrupt the electrical circuit in the event of an overload. The wounded wire 70 on wire element 60 reduces the associated resistance without affecting the heat energy needed to melt the fuse element 30 when a current cut-off threshold is met.

FIG. 2A is a cross sectional view taken along the longitudinal axis of a portion of fusible element 30. Wire element 70 is wound about wire element 60 which is wound about core 50 to define the fusible element. Although this figure illustrates that wire element 70 is in contact with core 50, in one embodiment the portions of wire element 60 in between the windings of wire element 70 may be compressed on core 50 depending on the tension employed when winding the combination of wire element 60 and 70 about core 50.

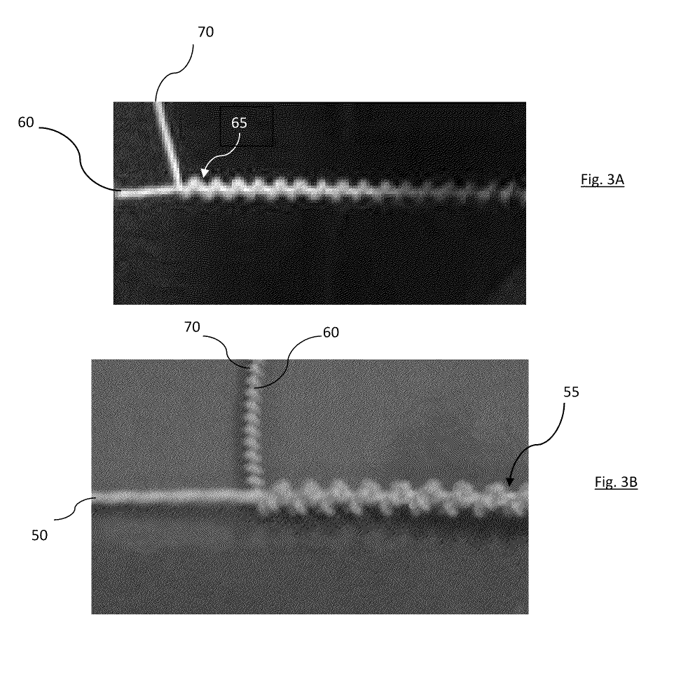

FIGS. 3A and 3B illustrate an exemplary process for forming the double wound fusible element 30. In particular, FIG. 3A illustrates the winding of wire element 70 about wire element 60 a plurality of windings. The winding of wire element 70 about wire element 60 forms a plurality of interstices 65 between the respective windings. The frequency of the windings of wire element 70 about wire element 60 and consequently the number of interstices 65 therebetween may vary depending on the desired rating of the fuse. FIG. 3B illustrates the winding of the combination of wire elements 60 and 70 about core 50. The winding of the combined wire elements 60 and 70 about core 50 form a plurality of interstices 55 between the respective windings. The contact of the wire elements 60 and 70 about the core 50 provides heat transfer from the wire to the core. In addition, by utilizing this double wound configuration, the mass of the fusible element 30 is increased which significantly increases the I²t value.

As noted briefly above, the I²t value is the measurement of energy required to blow the fuse element 30 which corresponds to the measurement of the damaging effect of an overcurrent condition on the protected device or circuit. In particular, I²t is a calculation of how many overcurrent pulses the fuse can withstand. This is done with the comparison of I²t of the pulse and the fuse which is referred to as “relative” I²t. By employing a double wound fusible wire (60, 70) configuration about core 50, the mass of the fusible element 30 is increased. With this increased mass, the amount of heat that the fusible element 30 generates due to an overcurrent condition is increased. Based on testing, it is believed that the I²t value using the double wound configuration in accordance with the present disclosure is increased approximately 250%-300% as compared with a single wound configuration (i.e. only employing wire element 60).

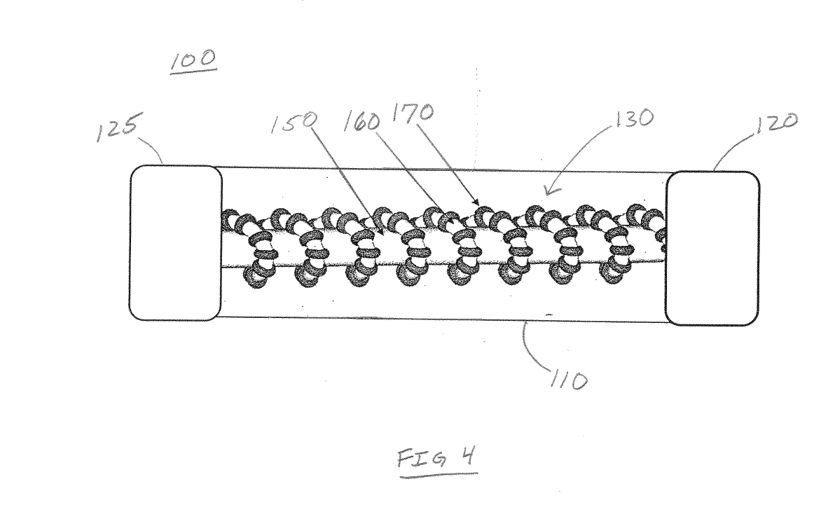

FIG. 4 is a perspective view (not drawn to scale) of an alternative fuse 100 employing the double wound fusible element shown with reference to FIG. 2. In particular, fuse 100 includes a housing 110 which may be referred to as a tube or cartridge. Housing 110 may be made from a ceramic or similar material. Each of a pair of electrically conductive end caps 120, 125 is positioned at the respective ends of housing 110 to contain fusible element 30 therein. In addition, the respective ends of fusible element 130 are electrically connected to end caps 120 and 125 usually by soldering. As noted above, fusible element 30 comprises wire element 170 wound orthogonally about a longitudinal axis of wire element 160 and the combination of wire elements 160 and 170 are wound about core 150 a plurality of turns or windings. The wire elements 160 and 170 used to form the double wound fusible element 130 comprise electrically conductive material configured to melt at a predetermined temperature to interrupt the electrical circuit in the event of a prolonged overload condition.

While the present invention has been disclosed with reference to certain embodiments, numerous modifications, alterations and changes to the described embodiments are possible without departing from the sphere and scope of the present invention, as defined in the appended claim(s). Accordingly, it is intended that the present invention not be limited to the described embodiments, but that it has the full scope defined by the language of the following claims, and equivalents thereof.

What is claims is:

1. A fusible element for use within a circuit protection device, said fusible element comprising:
an insulated core having a longitudinal axis;
a first wire wound about said core along the longitudinal axis of said core; and
a second wire wound substantially orthogonally about a longitudinal axis of the first wire such that said fusible element is configured to withstand a plurality of overcurrent pulses without melting.

2. The fusible element of claim 1 wherein said first wire wound about said core defines a plurality of windings and a corresponding plurality of interstices defined therebetween.

3. The fusible element of claim 1 wherein said second wire wound about said first wire defines a plurality of windings and a corresponding plurality of interstices defined therebetween.

4. The fusible element of claim 1 wherein said core comprises glass yarn.

5. A fuse comprising:
a housing defining a cavity therein;
a first and second terminals extending through corresponding openings in a lower portion of said housing and into said cavity; and
a fusible element having a first end electrically connected to said first terminal and a second end electrically connected to said second terminal within said cavity, said fusible element comprising
an insulated core having a longitudinal axis;
a first wire wound about said core along the longitudinal axis of said core; and
a second wire wound substantially orthogonally about a longitudinal axis of the first wire.

6. The fuse of claim 5 wherein said housing is defined by a cap connected to a base, said base including said openings through which said first and second terminals extend.

7. The fuse of claim 5 further comprising an arc quenching material disposed within said housing.

8. The fuse of claim 5 wherein said core comprises glass yarn.

9. The fuse of claim 5 wherein said first wire wound about said core defines a plurality of windings and a corresponding plurality of interstices defined therebetween.

10. The fuse of claim 5 wherein said second wire wound about said first wire defines a plurality of windings and a corresponding plurality of interstices defined therebetween.

11. A fuse comprising:
a housing defining a cavity therein;
a first end cap attached to a first end of said housing;
a second end cap attached to a second end of said housing; and
a fusible element disposed in said cavity, said fusible element having a first end electrically connected to said first end cap and a second end electrically connected to said second end cap, said fusible element comprising
an insulated core having a longitudinal axis;
a first wire wound about said core along the longitudinal axis of said core; and
a second wire wound substantially orthogonally about a longitudinal axis of the first wire.

12. The fuse of claim 11 wherein said first end of said fusible element is connected to said first end cap via solder, and said second end of said fusible element is connected to said second end cap via solder.

13. The fuse of claim 11 wherein said housing is a cylindrically shaped tube.

14. The fuse of claim 11 further comprising an arc quenching material disposed within said housing.

15. The fuse of claim 11 wherein said first wire wound about said core defines a plurality of windings and a corresponding plurality of interstices defined therebetween.

16. The fuse of claim 11 wherein said second wire wound about said first wire defines a plurality of windings and a corresponding plurality of interstices defined therebetween.
